(19) United States
(12) Patent Application Publication
(10) Pub. No.: US 2010/0158105 A1
(43) Pub. Date: Jun. 24, 2010

(54) POST-PROCESSING ENCODING SYSTEM AND METHOD

(75) Inventors: Atul Garg, Sunnyvale, CA (US); Lashminarayan Venkatesan, Mumbai (IN); Jackson Lee, Los Altos Hills, CA (US); Ignatius Tjandrasuwita, Atherton, CA (US)

Correspondence Address: NVIDIA C/O MURABITO, HAO & BARNES LLP, TWO NORTH MARKET STREET, THIRD FLOOR, SAN JOSE, CA, 95113, US

(73) Assignee: NVIDIA CORPORATION, Santa Clara, CA (US)

(21) Appl. No.: 12/340,442

(22) Filed: Dec. 19, 2008

(51) Int. Cl. H04B 1/66; G06K 9/36

(52) U.S. Cl. 375/240.03; 375/E07.139

(57) ABSTRACT

Quantization post-processing encoding systems and methods are described. In one embodiment an encoding system includes a quantization module, a quantization coefficient buffer, and a quantization post-processing module. The quantization module performs quantized encoding of information. The quantization coefficient buffer stores results of the quantized module. The quantization post-processing module provides adjustment information to the quantization coefficient buffer for utilization in adjusting the results from the quantized module stored in the quantization coefficient buffer without unduly impacting image quality.

### FIELD OF THE INVENTION

The present invention relates to the field of video encoding.

### BACKGROUND OF THE INVENTION

Electronic systems and circuits have made a significant contribution towards the advancement of modern society and are utilized in a number of applications to achieve advantageous results. Numerous electronic technologies such as digital computers, calculators, audio devices, video equipment, and telephone systems facilitate increased productivity and cost reduction in analyzing and communicating data, ideas and trends in most areas of business, science, education and entertainment. Frequently, these activities involve video encoding and decoding. However, encoding and decoding can involve complicated processing that occupies valuable resources and consumes time.

The continuing spread of digital media has led to a proliferation of video content dissemination. Video content typically involves large amounts of data that are relatively costly to store and communicate. Encoding and decoding techniques are often utilized to attempt to compress the information. However, as higher compression ratios are attempted by encoding and decoding techniques, the loss of some information typically increases. If there is too much information “lost” in the compression the quality of the video presentation and user experience deteriorates. These encoding typically attempts to balance compression of raw data against the quality of video playback.

Video compression techniques such as H.264 compression use temporal and spatial prediction to compress raw video streams. A typical compression engine may contain a motion search module, a motion compensation module, a transform module, and an entropy coding module as shown in FIG. 1. Raw video pixel data is input and processed by a motion search stage to determine motion vectors. These motion vectors are used by the motion compensation module to calculate residual pixel values. The residual pixel values are then sent to a transform engine. The transform engine performs discrete cosine transform on the residual data, quantizes the transformed coefficients and propagates the quantized coefficients to entropy coding stage for bit stream generation.

### SUMMARY

Quantization post-processing encoding systems and methods are described. In one embodiment, an encoding system includes a quantization module, a quantization coefficient buffer, and a quantization post-processing module. The quantization module performs quantized encoding of information. The quantization coefficient buffer stores results of the quantized module. The quantization post-processing module provides adjustment information to the quantization coefficient buffer for utilization in adjusting the results from the quantized module stored in the quantization coefficient buffer without unduly impacting image quality.

### DESCRIPTION OF THE DRAWINGS

The accompanying drawings, which are incorporated in and form a part of this specification, are included for exemplary illustration of the principles of the present invention and not intended to limit the present invention to the particular implementations illustrated therein. The drawings are not to scale unless otherwise specifically indicated.

FIG. 1 is a block diagram of a typical compression engine containing a motion search module, a motion compensation module, a transform module, and an entropy coding module.

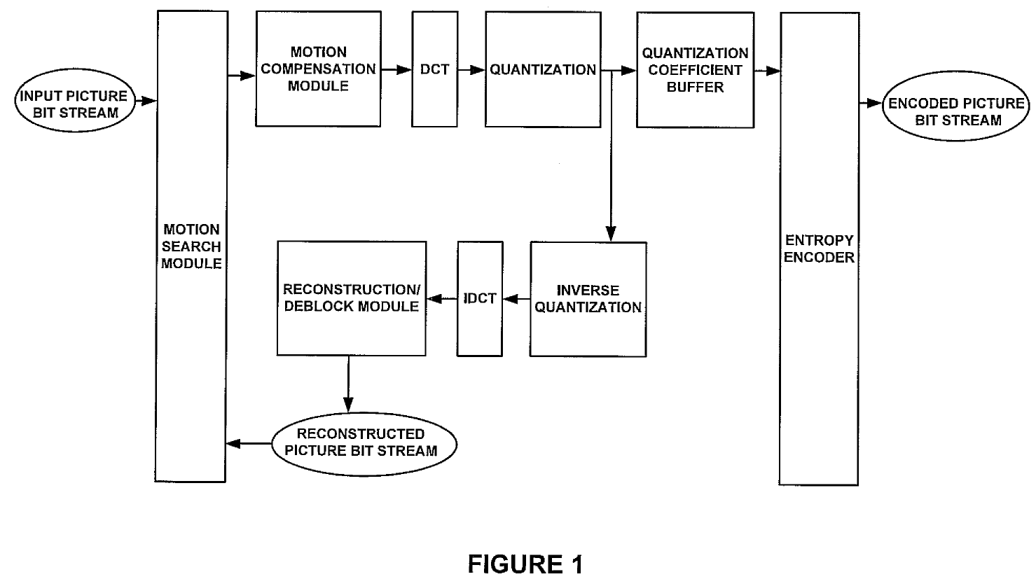

FIG. 2A is a block diagram of an exemplary encoding architecture in accordance with one embodiment of the present invention.

FIG. 2B is a block diagram of an exemplary computer system upon which quantization post processing can be implemented in accordance with one embodiment of the present invention.

FIG. 3 is a block diagram of an exemplary quantization post-processing encoder system in accordance with one embodiment of the present invention.

FIG. 4 is a block diagram of exemplary quantization post-processing module interfaces in accordance with one embodiment of the present invention.

FIG. 5 is a block diagram of data flow in an exemplary quantization post-processing system in accordance with one embodiment of the present invention.

FIG. 6 is block diagram of coefficients in an exemplary zigzag order in accordance with one embodiment of the present invention.

FIG. 7 is a flow chart of an exemplary quantization post-processing method in accordance with one embodiment of the present invention.

FIG. 8 shows an exemplary architecture that incorporates an exemplary video processor or graphics processor in accordance with one embodiment of the present invention.

FIG. 9 shows a block diagram of exemplary components of a handheld device in accordance with one embodiment of the present invention.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one ordinarily skilled in the art that the present invention may be practiced without these specific details. In other instances, well known methods, procedures, components, and circuits have not been described in detail as not to unnecessarily obscure aspects of the current invention.

Some portions of the detailed descriptions which follow are presented in terms of procedures, logic blocks, processing, and other symbolic representations of operations on data bits within a computer memory. These descriptions and representations are the means generally used by those skilled in data processing arts to effectively convey the substance of their work to others skilled in the art. A procedure, logic block, process, etc., is here, and generally, conceived to be a self-consistent sequence of steps or instructions leading to a desired result. The steps include physical manipulations of physical quantities. Usually, though not necessarily, these quantities take the form of electrical, magnetic, optical, or quantum signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are associated with the appropriate physical quantities and are merely convenient labels applied to these quantities. Unless specifically stated otherwise as apparent from the following discussions, it is appreciated that throughout the present application, discussions utilizing terms such as “processing”, “computing”, “calculating”, “determining”, “displaying” accessing,” “writing,” “including,” “storing,” “transmitting,” “traversing,” “associating,” “identifying” or the like, refer to the action and processes of a computer system, or similar processing device (e.g., an electrical, optical, or quantum, computing device), that manipulates and transforms data represented as physical (e.g., electronic) quantities. The terms refer to actions and processes of the processing devices that manipulate or transform physical quantities within a computer system's component (e.g., registers, memories, other such information storage, transmission or display devices, etc.) into other data similarly represented as physical quantities within other components.

Portions of the detailed description that follows are presented and discussed in terms of a method. Although steps and sequencing thereof are disclosed in figures herein describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “writing,” “including,” “storing,” “transmitting,” “traversing,” “associating,” “identifying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Computing devices typically include at least some form of computer readable media. Computer readable media can be any available media that can be accessed by a computing device. By way of example, and not limitation, computer readable medium may comprise computer storage media and communication media. Computer storage media includes volatile and nonvolatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information and which can be accessed by a computing device. Communication media typically embodies computer readable instructions, data structures, program modules, or other data in a modulated data signals such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

Some embodiments may be described in the general context of computer-executable instructions, such as program modules, executed by one or more computers or other devices. Generally, program modules include routines, programs, objects, components, data structures, etc, that perform particular tasks or implement particular abstract data types. Typically the functionality of the program modules may be combined or distributed as desired in various embodiments.

Although embodiments described herein may make reference to a CPU and a GPU as discrete components of a computer system, those skilled in the art will recognize that a CPU and a GPU can be integrated into a single device, and a CPU and GPU may share various resources such as instruction logic, buffers, functional units and so on; or separate resources may be provided for graphics and general-purpose operations. Accordingly, any or all of the circuits and/or functionality described herein as being associated with GPU could also be implemented in and performed by a suitably configured CPU.

Further, while embodiments described herein may make reference to a GPU, it is to be understood that the circuits and/or functionality described herein could also be implemented in other types of processors, such as general-purpose or other special-purpose coprocessors, or within a CPU.

The present invention facilitates efficient effective video compression. In one embodiment, the present invention facilitates reduction of adverse compression impacts associated with artifacts.

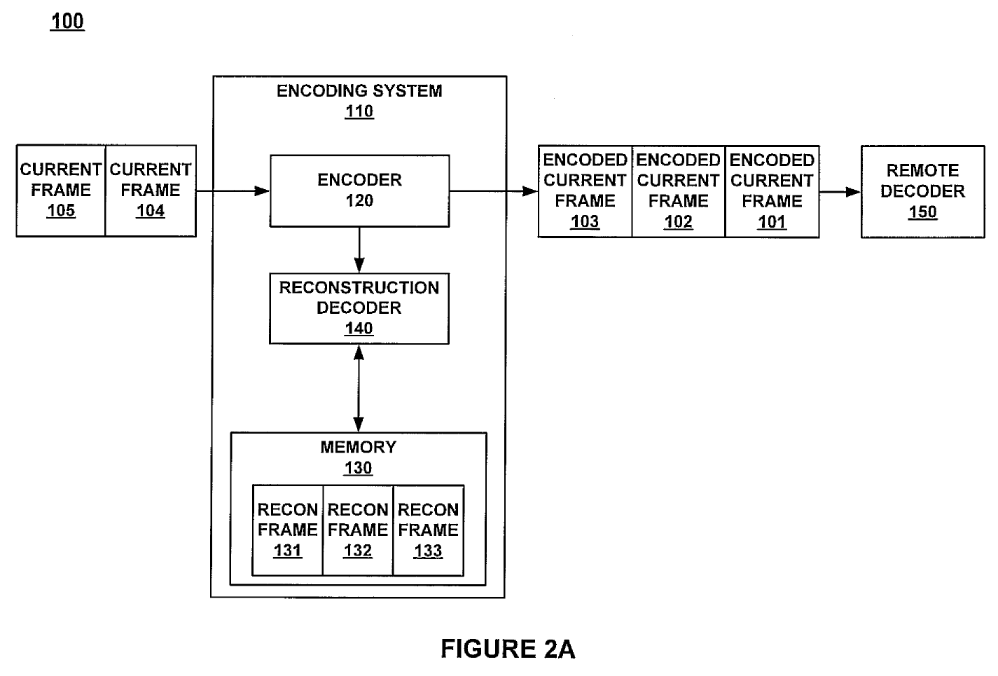

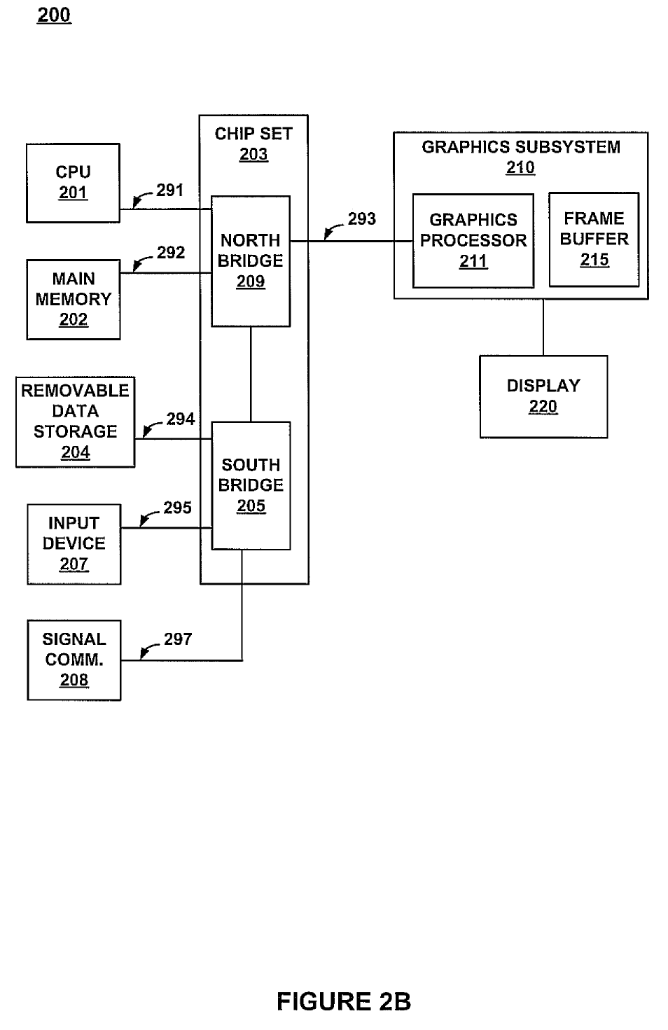

FIG. 2A is a block diagram of an exemplary encoding architecture 100 in accordance with one embodiment of the present invention. Encoding architecture 100 includes encoding system 110 and remote decoder 150. Encoding system 110 receives current frames (e.g., current frames 104 and 105), encodes the current frames, and then forwards the encoded current frames (e.g., current frames 101, 102 and 103) to remote decoder 150. Encoding system 100 includes encoder 120, reconstruction decoder 140 and memory 130. The encoder 120 encodes the frames and forwards them to remote decoder 150 and reconstruction decoder 140. Reconstruction decoder 140 decodes the frames and forwards them to memory 130 for storage as reconstructed frames 131 132 and 133. In one exemplary implementation, the reconstructed frames 131, 132 and 133 correspond to current frames 101, 102 and 103.

FIG. 2B is a block diagram of an exemplary computer system 200 as one embodiment of a computer system upon which embodiments of the present invention can be implemented. Computer system 200 includes central processor unit 201, main memory 202 (e.g., random access memory), chip set 203 with north bridge 209 and south bridge 205, removable data storage device 204, input device 207, signal communications port 208, and graphics subsystem 210 which is coupled to display 220. Computer system 200 includes several busses for communicatively coupling the components of computer system 200. Communication bus 291 (e.g., a front side bus) couples north bridge 209 of chipset 203 to central processor unit 201. Communication bus 292 (e.g., a main memory bus) couples north bridge 209 of chipset 203 to main memory 202. Communication bus 293 (e.g., the Advanced Graphics Port interface) couples north bridge of chipset 203 to graphic subsystem 210. Communication buses 294, 295 and 297 (e.g., a PCI bus) couple south bridge 205 of chip set 203 to removable data storage device 204, input device 207, signal communications port 208 respectively. Graphics subsystem 210 includes graphics processor 211 and frame buffer 215.

The components of computer system 200 cooperatively operate to provide versatile functionality and performance. In one exemplary implementation, the components of computer system 200 cooperatively operate to provide predetermined types of functionality, even though some of the functional components included in computer system 200 may be defective. Communications bus 291, 292, 293, 294, 295 and 297 communicate information. Central processor 201 processes information. Main memory 202 stores information and instructions for the central processor 201. Removable data storage device 204 also stores information and instructions (e.g., functioning as a large information reservoir). Input device 207 provides a mechanism for inputting information and/or for pointing to or highlighting information on display 220. Signal communication port 208 provides a communication interface to exterior devices (e.g., an interface with a network). Display device 220 displays information in accordance with data stored in frame buffer 215. Graphics processor 211 processes graphics commands from central processor 201 and provides the resulting data to frame buffer 215 for storage and retrieval by display monitor 220.

### Encoder Architecture

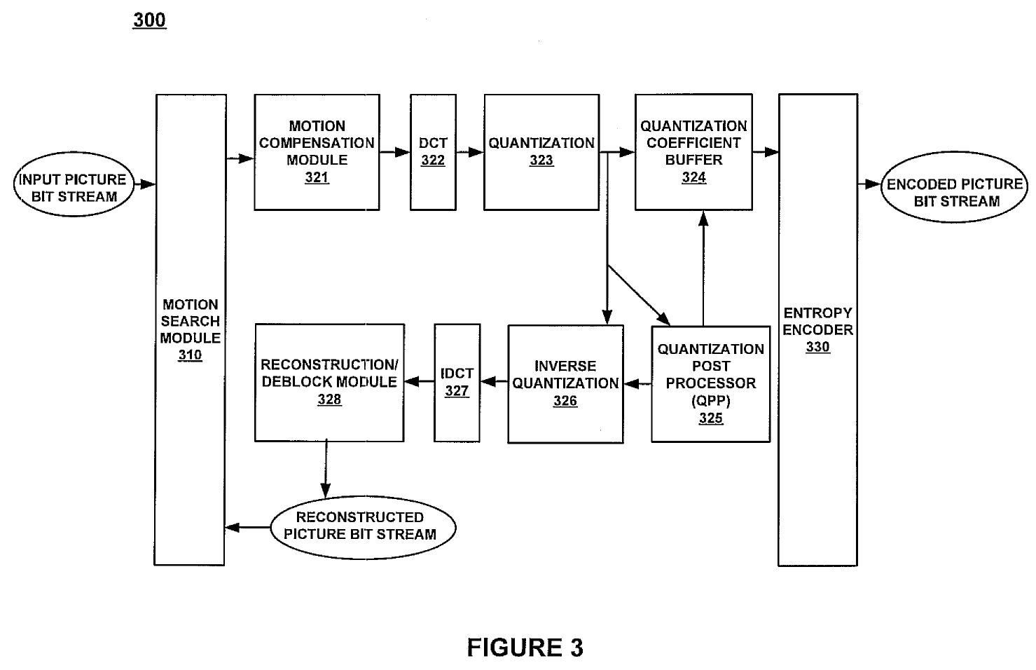

With reference now to FIG. 3, a block diagram of quantization post-processing encoder system 300 is depicted, in accordance with one embodiment of the present invention. Quantization post-processing encoder system 300 includes motion search engine 310, motion compensation module 321, transform module 322, quantization module 323, quantization coefficient buffer module 324, quantization post processor 325, inverse quantization module 324, inverse transform module 327, reconstruction/deblock module 328 and entropy encoder 330. Motion search engine 310 is communicatively coupled to reconstruction/deblock module 328 and motion compensation module 321 which is communicatively coupled to transform module 322 which in turn is communicatively coupled to quantization module 323. Quantization module 323 is communicatively coupled to quantization coefficient buffer module 324 and inverse quantization module 324 which is communicatively coupled to inverse transform module 327 which in turn s communicatively coupled to reconstruction/deblock module 328. Quantization post-processing module 325 is communicatively coupled to quantization module 323, inverse quantization module 326 and quantization coefficient module 324 which is communicatively coupled to entropy encoder 330. While quantization post-processing encoder system 300 is shown as incorporating specific, enumerated features, elements, and arrangements, it is understood that embodiments are well suited to applications involving additional, fewer, or different features, elements, or arrangements.

The components of quantization post-processing encoder system 300 cooperatively operate to facilitate increased compression ratios. Motion search module 310 receives an input bit stream of raw video data (e.g., picture data, frame data, etc.) and processes it, often in macroblocks of 16×16 pixels, and the processed information is forwarded to a motion compensation module 321 In one embodiment, the processing by motion search module 310 includes comparing the raw video data on a picture or frame by fame basis with reconstructed picture or frame data received from reconstruction/deblock module 328 to detect “image motion” indications. Transform engine 322 receives motion compensated information and performs additional operations (e.g., discrete cosine transform, etc.), and outputs data (e.g., transformed coefficients, etc.) to quantization module 323. Quantization module 323 performs quantization of the received information the quantization results are forwarded to quantization coefficient buffer 324, inverse quantization module 326 and quantization post-processing module 325. Buffers, such as quantization buffer 324 can be used to buffer or temporarily store information and to increase efficiency by facilitating some independence and simultaneous operations in various encoding stages. For example, quantization coefficient buffer 324 stores results of quantization module 323. Entropy encoder 330 takes the data from quantization buffer 324, and outputs an encoded bitstream. The reconstruction pipe including inverse quantization module 326, inverse transform module 327 and reconstruction/deblock module 328 perform operations directed at creating a reconstructed bit stream associated with a frame or picture.

Quantization post-processing module 325 operates to increase compression ratio (e.g., the ratio of the original raw pixel stream size to the encoded bitstream size, etc.). Quantization post-processing module 325 provides adjustment information to the quantization coefficient buffer 324 for utilization in adjusting stored results from quantization module 323 without unduly impacting image quality.

The input to quantization post-processing module 325 comes from the output of quantization module 323 and the output of the quantization post-processing module 325 goes to the input of the quantization coefficient buffer 324 and the inverse quantization module 326. For example, quantization post-processing module 325 provides the adjustment information to inverse quantization module 326 for utilization in adjusting results of the quantization module 323. The quantization post-processing module 325 processes the output of quantization module 323 at-speed, and reduces artifacts introduced by quantization module to either increase compression or increase bit-stream quality at constant compression. In embodiment, quantization post-processing module 325 determines a cost associated with encoding a block of video pixels based upon a range of quantization coefficients. In one exemplary implementation, quantization post-processing module 325 determines if the coefficients associated with a block of pixels indicate the pixels values are insignificant and directs the quantization coefficient buffer 324 to alter coefficients associated with a block of pixels. For example, quantization post-processing module 325 directs the quantization coefficient buffer 324 to replace a current quantized coefficient by zero value.

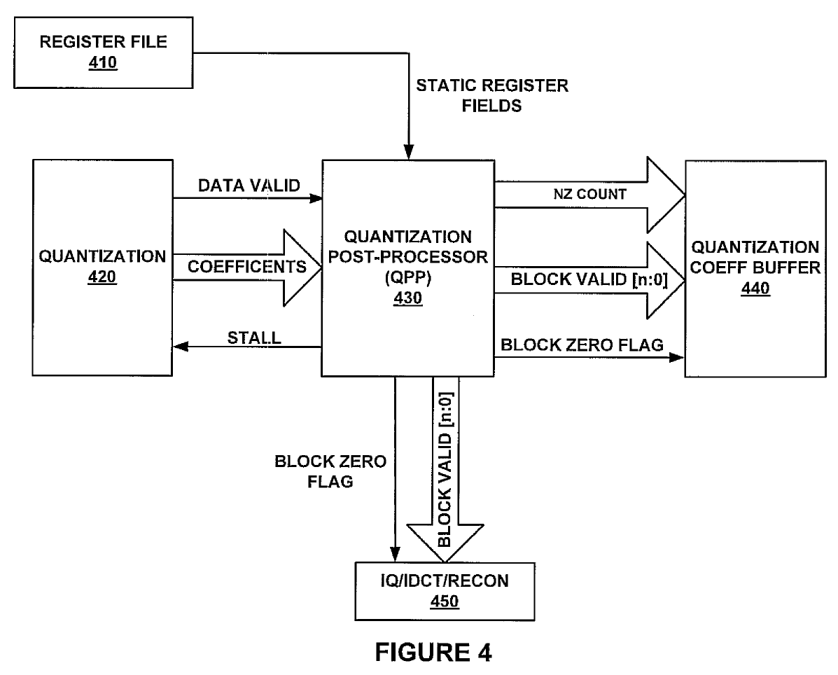

FIG. 4 is a block diagram of exemplary quantization post-processing module interfaces in accordance with one embodiment of the present invention. In one embodiment, quantization post-processing module 430 interfaces with register file 410, quantization module 420, quantized coefficient buffer 440 and reconstruction pipe 450. Quantization post-processing module 430 receives quantized coefficients from quantization module 420 and user programming from register module 410. The outputs from quantization post-processing module 430 go to quantization buffer 440 and modules of reconstruction pipe 450. Quantization post-processing module 430 is active during both intra (I) and inter (P) macroblocks. During typical encoder operations, quantized coefficients go from the output of quantization module to quantization buffer and to inverse quantization module. The quantization coefficient buffer 440 validates the data and sends the entire block to entropy encoder. In one embodiment, the quantization buffer 440 performs the validation after it receives an entire block of information (e.g., a 4×4 block, 16×16 block, etc.).When the quantization post-processing module 430 is enabled it processes coefficients in parallel with the writing of coefficients into the quantization coefficient buffer 440 and the writing of reconstructed coefficients at the output of reconstruction stage represented by the reconstruction pipe 450 modules (e.g., an inverse quantization module, an inverse transform module, a reconstruction module, etc.).

A quantization post-processing module can perform a variety of operations. For example the quantization post-processing module can scan the coefficients in a block (e.g., 4×4 block, 8×8 block, etc.) for coefficients with in a user defined range. The quantization post-processing module can also scan the coefficients to calculate zero run vector for each non-zero coefficient. In one embodiment, the quantization post-processing module calculates a cost of each block based on the coefficient range, macroblock type (e.g., I, P etc.) and zero run vector. It then combines the individual block costs to form higher level block costs such as 4×8, 8×4, 8×8, 8×16, 16×8, 16×16 based on register inputs. A quantization post-processing module can calculate the block costs over both luma and chroma coefficients based on register inputs. A quantization post-processing module can also perform user defined actions such as comparison of a particular size block cost with a user defined threshold. In one exemplary implementation, the quantization post-processing module can send results of the block operations to its output modules for further processing. One such operation is to replace the current quantized coefficients by a value of zero.

If the accumulated coefficient cost is less than or equal to the threshold, the coefficients in a particular block are considered insignificant to encoder quality and are converted to zero. At the end of every block, the quantization post-processing module sends a block valid and block zero signal to both quantization coefficient buffer and the reconstruction pipe modules. To facilitate simpler control, a separate block valid can be sent for each block. The quantization post-processing module also calculates the non-zero coefficient count, which is one of the parameters used in the entropy coding stage.

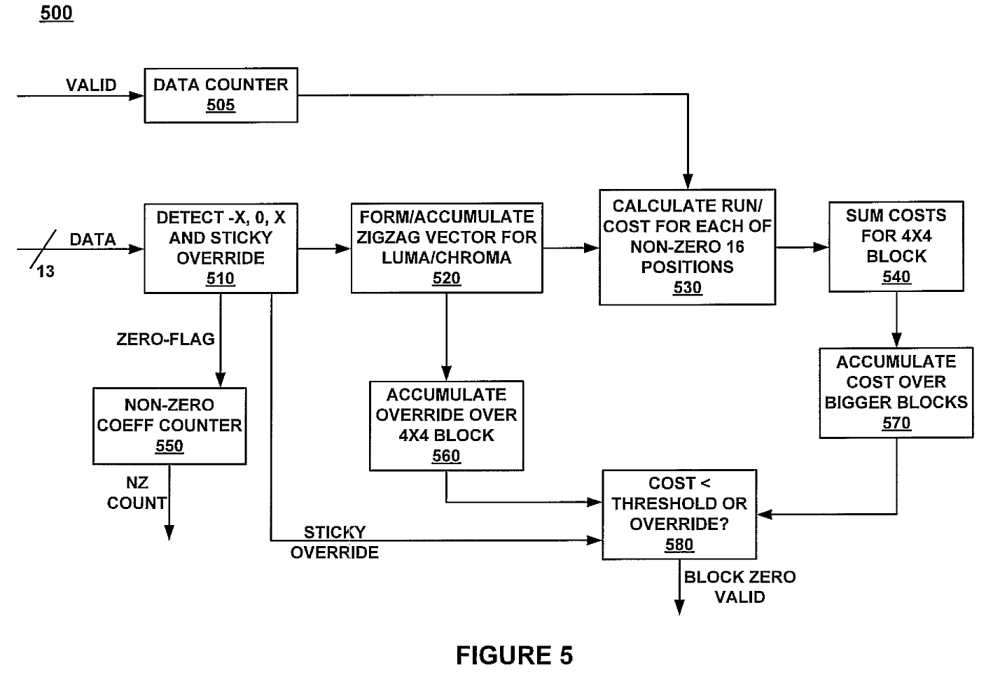

FIG. 5 is a block diagram of data flow in exemplary quantization post-processing system 500 in accordance with one embodiment of the present invention. In one exemplary implementation, input coefficients are 13 bits each and are sent through range detector 510. Quantization post-processing system 500 includes range detection module 510, reorder module 520, cost determination module 530, cost summing accumulation module 540, non-zero coefficient counter 550, accumulation override module 560, larger block cost accumulation module 570 and zero valid indication determination module 580.

The components of quantization post-processing system 500 cooperatively operate to perform quantization post processing. Range detection module 510 detects if coefficient values fall within a range. Range detection module 510 also forwards sticky override values to zero valid indication determination module 580. Reorder module 520 reorders the results of the output of the range detection module. The reorder module 520 also forms and accumulates the coefficients in a zigzag order vector associated with luminance and chrominance. Cost determination module 530 determines a cost for each non-zero position based upon results of the reorder module 510. Determining the cost includes calculating a cost that is dependent on a weighted sum of each reordered level. In one exemplary implementation, the cost is calculated for a basic block (e.g., a 4×4 block, etc.). Data counter 505 indicates to the cost determination module 530 when a reordered set of bits is available to process. Non-zero coefficient counter 550 counts the non-zero coefficients based upon the results of the detection module 510 and forwards the count results to the entropy coding stage. Cost summing accumulation module 540 sums costs associated with a block. Accumulation override module 560 accumulates overrides in a block and forwards the results to the zero valid indication determination module 580. Larger block cost accumulation module 570 accumulates costs associated with larger blocks. Zero valid indication determination module 580 determines if a cost is associated with a block zero indication. In one embodiment, the accumulated costs are compared and the results are forwarded as output for the quantization post processing. In one exemplary implementation, a comparison is performed and determination is made if the costs are lower than a threshold values or override is set for one of the basic blocks in the larger block.

In one embodiment, quantization post processing is performed at speed with the rest of a pipeline and minimizes quantization post processing stalls in normal operation. The block valid and block zero flags can be generated within two cycles of the last coefficient reception from a quantization module. The data throttle into the quantization post processing from the upstream pipe guarantees at least 4 cycles unit the next 4×4 arrives and operations are seamless.

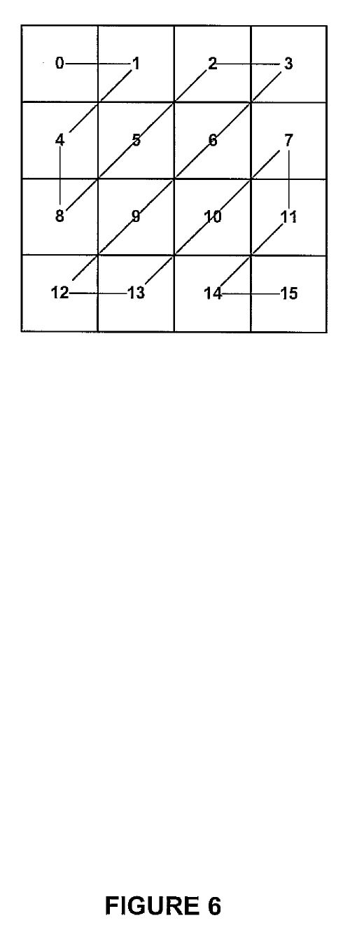

In one embodiment, input coefficients from a quantization module arrive in 4×4 row-order. The decision of whether to discard coefficients is based on a cost calculation that is dependent on a weighted sum of the levels. The weight of a level is configurable lookup dependent on the run of each coefficient. To calculate the run of a coefficient, the coefficients are ordered in zigzag order as shown in FIG. 6.

In one embodiment, in order to save local storage the coefficients are screened at read time, to determine whether the coefficient is within a range. In one exemplary implementation the coefficients themselves are not stored, rather screened bits are stored. If the absolute value of the coefficient is greater than X a sticky override flag is set. The sticky flag is set until the block processing is done. If the absolute value of the coefficient is within the range, the corresponding bit in the zigzag vector is set. In one exemplary implementation, 16 bits of buffer space are used for 16 coefficients while maintaining at speed operation. Once 4 rows are read, the zigzag vector is read in bit order and cumulatively processed for run/cost calculations and weight lookup. This can be implemented as a single combinatorial module instances 16 times in a cascaded fashion, with some special connections for some of the instances.

In one embodiment, chroma cost calculations are slightly different. The data throttle in chroma mode is thus, first the 4 chroma dc coefficients are sent, then the ac coefficients are sent with the dc values inserted in the respective position. The cost calculation in the algorithm is done in two steps. The run cost weighting of the dc values is to be calculated separately (e.g., in a separate independent 4×4 block) and this is ignored in the run of the ac coefficients. To achieve this, the inputs to the calculation module are tweaked so that the datapath is completely untouched. In one exemplary chroma dc mode, bit positions 15:4 are forced to 0 so the dc cost is automatically produced with the respective runs of the 4 dc values. In chroma ac mode the dc positions in the zigzag vector bit [0] in each 4×4 block is forced to 0. The dc cost is separately accumulated in one cycle, stored, and then added to the cost of the 8×8 ac block. This way, cost calculation is achieved for the luma and chroma blocks, and also for inter and intra macroblocks, without using any extra adders or extra logic for the quantization post-processing operation by playing with the control feeding into the datapath.

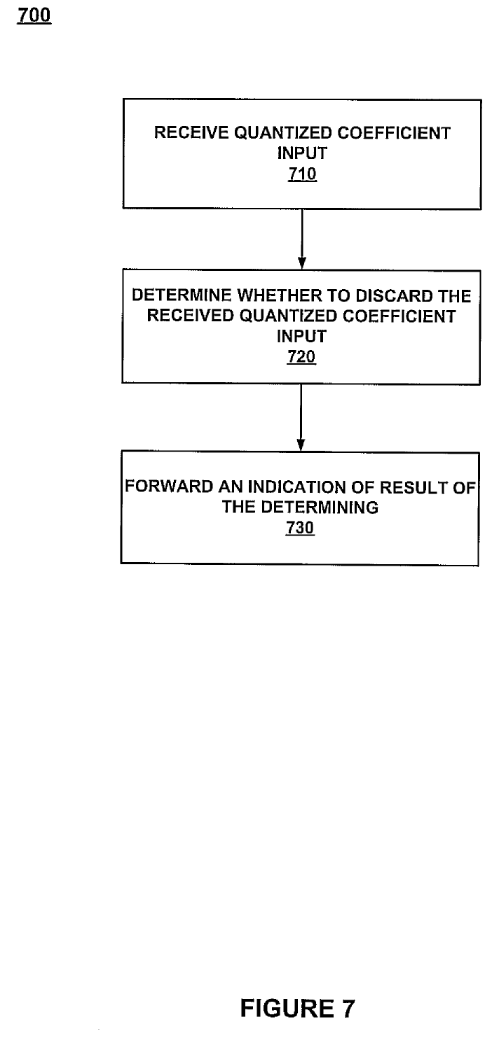

FIG. 7 is a flow chart of exemplary quantization post-processing method 700 in accordance with one embodiment of the present invention.

At block 710, quantized coefficient input is received. In one embodiment the coefficients are reordered in a zigzag pattern.

In block 720, a determination is made whether to discard the received quantized coefficient input. In one embodiment, determining whether to discard the received quantized coefficient input is based upon a cost determination that is dependent on a weighted sum of the levels. The cost determination can include a luma cost determination process and a chroma cost determination process.

In block 730, an indication of results of the whether to discard the received quantized coefficient input is forwarded.

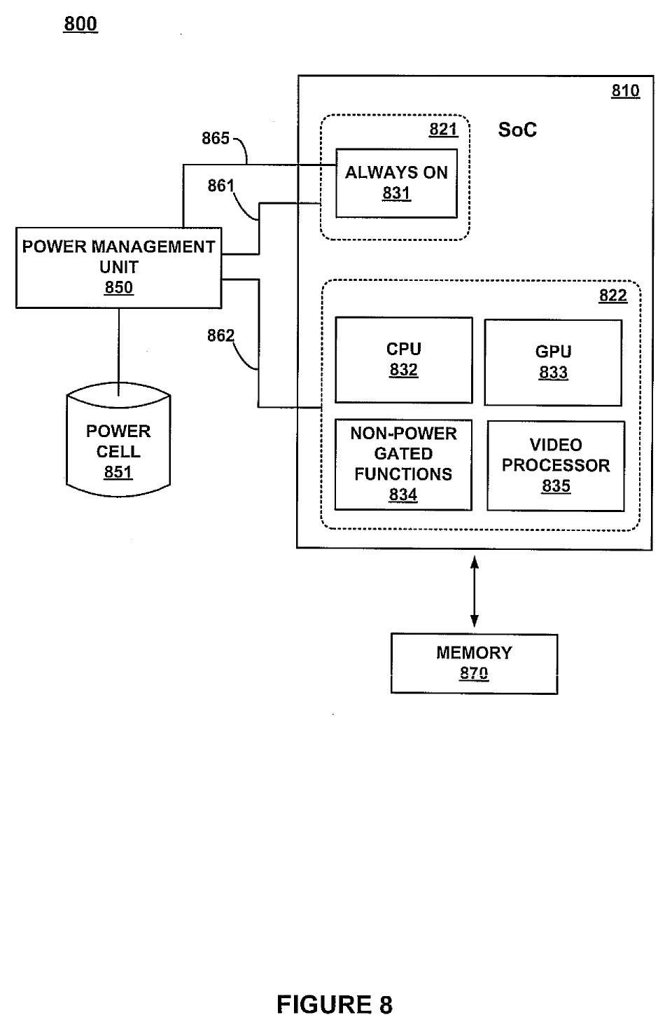

FIG. 8 shows an exemplary architecture that incorporates an exemplary video processor or graphics processor in accordance with one embodiment of the present invention. As depicted in FIG. 8, system 800 embodies a programmable SOC integrated circuit device 810 which includes a two power domains 821 and 822. The power domain 821 includes an “always on” power island 831. The power domain 822 is referred to as the core of the SOC and includes a CPU power island 832, a GPU power island 833, a non-power gated functions island 834, and an instance of the video processor. The FIG. 8 embodiment of the system architecture 800 is targeted towards the particular intended device functions of a battery-powered handheld SOC integrated circuit device. The SOC 810 is coupled to a power management unit 850, which is in turn coupled to a power cell 851 (e.g., one or more batteries). The power management unit 850 is coupled to provide power to the power domain 821 and 822 via the dedicated power rail 861 and 862, respectively. The power management unit 850 functions as a power supply for the SOC 810. The power management unit 850 incorporates power conditioning circuits, voltage pumping circuits, current source circuits, and the like to transfer energy from the power cell 851 into the required voltages for the rails 861-862.

In the FIG. 8 embodiment, the video processor is within the domain 822. The video processor provides specialized video processing hardware for the encoding of images and video. As described above, the hardware components of the video processor are specifically optimized for performing real-time video encoding. The always on power island 831 of the domain 821 includes functionality for waking up the SOC 810 from a sleep mode. The components of the always on domain 821 will remain active, waiting for a wake-up signal. The CPU power island 832 is within the domain 822. The CPU power island 832 provides the computational hardware resources to execute the more complex software-based functionality for the SOC 810. The GPU power island 833 is also within the domain 822. The GPU power island 833 provides the graphics processor hardware functionality for executing 3-D rendering functions.

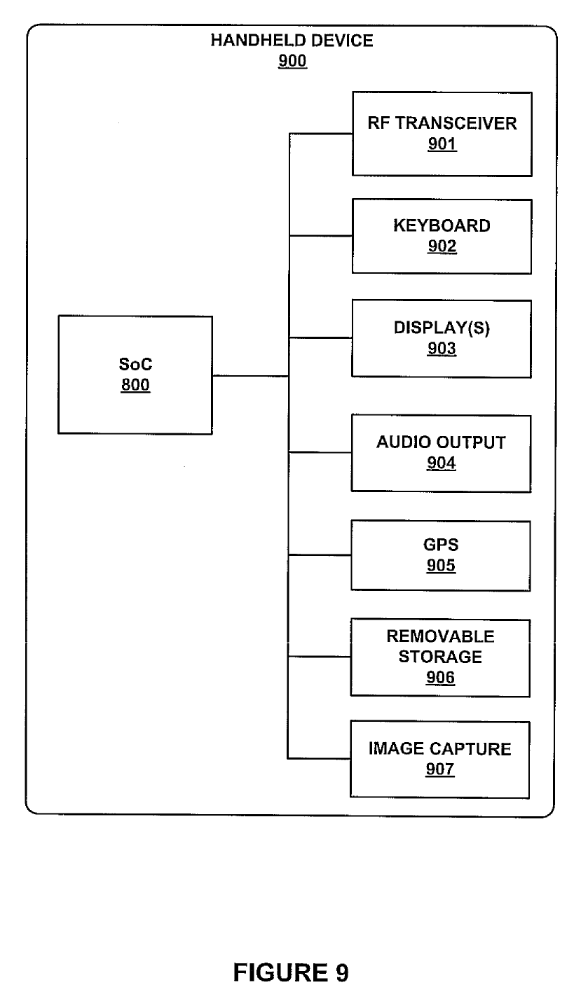

FIG. 9 shows a diagram showing the components of a handheld device 900 in accordance with one embodiment of the present invention. As depicted in FIG. 9, a handheld device 900 includes the system architecture 800 described above in the discussion FIG. 8. The handheld device 900 shows peripheral devices 901-907 that add capabilities and functionality to the device 900. Although the device 900 is shown with the peripheral devices 901-907, it should be noted that there may be implementations of the device 900 that do not require all the peripheral devices 901-907. For example, in an embodiment where the display(s) 903 are touch screen displays, the keyboard 902 can be omitted. Similarly, for example, the RF transceiver can be omitted for those embodiments that do not require cell phone or WiFi capability. Furthermore, additional peripheral devices can be added to device 900 beyond the peripheral devices 901-907 shown to incorporate additional functions. For example, a hard drive or solid state mass storage device can be added for data storage, or the like.

The RF transceiver 901 enables two-way cell phone communication and RF wireless modern communication functions. The keyboard 902 is for accepting user input via button pushes, pointer manipulations, scroll wheels, jog dials, touch pads, and the like. The one or more displays 903 are for providing visual output to the user via images, graphical user interfaces, full-motion video, text, or the like. The audio output component 904 is for providing audio output to the user (e.g., audible instructions, cell phone conversation, MP3 song playback, etc.). The GPS component 905 provides GPS positioning services via received GPS signals. The GPS positioning services enable the operation of navigation applications and location applications, for example. The removable storage peripheral component 906 enables the attachment and detachment of removable storage devices such as flash memory, SD cards, smart cards, and the like. The image capture component 907 enables the capture of still images or full motion video. The handheld device 900 can be used to implement a smart phone having cellular communications technology, a personal digital assistant, a mobile video playback device, a mobile audio playback device, a navigation device, or a combined functionality device including characteristics and functionality of all of the above.

Thus, the present invention facilitates improved compression ratios. The compression can be performed at run time with minimal stall impact on the pipe. The operations can be performed at speed in real time.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. The listing of steps within method claims do not imply any particular order to performing the steps, unless explicitly stated in the claim.

What is claimed is:

1. An encoding system comprising:
a quantization module for performing quantized encoding of information;
a quantization coefficient buffer for storing results of said quantization module; and
a quantization post-processing module for providing adjustment information to said quantization coefficient buffer for utilization in adjusting storage of said results of said quantized module without unduly impacting image quality.

2. An encoding system of claim 1 wherein said quantization post-processing module process the output of said quantization module at-speed.

3. An encoding system of claim 1 wherein said quantization post-processing module reduces artifacts introduced by said quantization module and stored in said quantized module.

4. An encoding system of claim 1 further comprises a discrete cosine transform module for performing a discrete cosine transform on residual data.

5. An encoding system of claim 4 wherein said quantization module quantizes transformed coefficients received from said discrete cosine transform module.

6. An encoding system of claim 1 wherein said quantization post-processing module also provides said adjustment to said information to an inverse quantization module for utilization in adjusting storage of said results of said quantization module.

7. An encoding system of claim 1 wherein said quantization post-processing module determines a cost associated with encoding a block of video pixels based upon a range of quantization coefficients.

8. An encoding system of claim 1 wherein said quantization post-processing module determines if the coefficients associated with a block of pixels indicate the pixels values are insignificant and directs said quantization coefficient buffer to alter coefficients associated with a block of pixels.

9. An encoding system of claim 1 wherein said quantization post-processing module directs said quantization coefficient buffer to replace a current quantized coefficient by zero value.

10. A quantization post-processing method comprising:
receiving quantized coefficient input;
determining whether to discard said received quantized coefficient input; and
forwarding an indication of results of said determining.

11. A quantization post-processing method of claim 10 wherein said determining whether to discard said received quantized coefficient input is based upon a cost determination that is dependent on a weighted sum of the levels.

12. A quantization post-processing method of claim 10 wherein said cost determination includes a luma cost determination process.

13. A quantization post-processing method of claim 10 further comprising performing a chroma cost determination.

14. A quantization post-processing method of claim 10 further comprising reordering coefficients in a zigzag pattern.

15. A quantization post-processing system comprising:
a range detection module for detecting if coefficient values fall within a range;
a reorder module for reordering the results of the output of the range detection module;
a cost determination module for determining a cost for each non-zero position based upon results of the reorder module; and
a zero valid indication determination module for determining a cost is associated with a block zero indication.

16. A quantization post-processing system of claim 15 further comprising a non-zero coefficient counter for counting the non-zero coefficients based upon the results of the detection module.

17. A quantization post-processing system wherein said range detection module also forwards sticky override values to zero valid indication determination module.

18. A quantization post-processing system of claim 15 wherein said reorder module also forms and accumulates said coefficients in a zigzag order vector associated with luminance and chrominance;

19. A quantization post-processing system of claim 15 wherein said determining said cost includes calculating a cost that is dependent on a weighted sum of each reordered level.

20. A quantization post-processing system of claim 15 further comprising accumulation modules for summing costs associated with a block, accumulating costs associated with larger blocks accumulating overrides in a block and forwarding the results to said zero valid indication determination module.
